(19) United States
(12) Patent Application Publication
(10) Pub. No.: US 2009/0138687 A1
(43) Pub. Date: May 28, 2009

(54) MEMORY DEVICE HAVING DATA PROCESSING FUNCTION

(76) Inventor: Se-Jin Kang, Seoul (KR)

Correspondence Address: BIRCH STEWART KOLASCH & BIRCH, PO BOX 747, FALLS CHURCH, VA, 22040-0747, US

(21) Appl. No.: 12/298,724

(22) PCT Filed: Jul. 13, 2007
(86) PCT No.: PCT/KR2007/003434

§ 371 Date: Oct. 27, 2008

(30) Foreign Application Priority Data
Jul. 14, 2006 (KR) 10-2006-0066585

(51) Int. Cl. G06F 9/30

(52) U.S. Cl. 712/225; 712/E09.016

(57) ABSTRACT

A memory device having a data processing function is disclosed. The memory device can include a process area, in which process command information is written by a processor; a storage area, in which one or more data is written; an output area, in which display data selected by the processor from among the data written in the storage area is written; and a processing unit, which performs one or more processes of copying data, computing data, and transmitting display data to an external outputting device, in correspondence with the process command information. According to some aspects of the present invention, the memory device is able to independently perform commands received from the processor, and does not require a separate memory for storing data that will be transmitted to an external outputting device, so that the processing efficiency of the processor can be enhanced.

### CROSS-REFERENCE TO RELATED APPLICATIONS

This application claims foreign priority benefits under 35 U.S.C. sctn. 119(a)-(d) to PCT/KR2007/003434, filed Jul. 13, 2007, which is hereby incorporated by reference in its entirety.

### BACKGROUND

1. Technical Field

The present invention relates to a memory device, more particularly to a memory device having a data processing function.

2. Description of the Related Art

In a portable device, a memory device is equipped such that it is coupled to a processor (e.g. a central processing unit) that performs pre-designated processing routines. A boot code for booting the processor, code information for operation, data to be processed or the processed data, etc. can be stored in the memory device.

A conventional, general method of controlling the memory is to use interrupts. This is a method in which the processor sends a command (e.g. a command to transmit data to a receiver terminal) to a built-in or coupled input/output controller, and the input/output controller performs processing routines corresponding to the received command, and then transmits an interrupt signal (e.g. a processing complete signal) to the processor, to complete a series of tasks.

In the conventional method of controlling the memory using interrupts, if an independent input/output controller is equipped, there has been an advantage in which the processor can perform another task even while the input/output controller performs the received command. However, the problem still remains that the processor has to be involved directly in communications between the memory device and the input/output device. Also, as some cases may require an interface, the prospects of freely exchanging memory devices are limited.

Also, a processor equipped in a portable device displays certain information through a display unit. In this case, the information displayed by the processor through the display unit may not only be basic information, such as the current time, data, remaining battery power information, received signal strength information, etc., but also multimedia information (e.g. image data, audio data, etc.) processed by the processor.

Also, in order to display certain information through the display unit, the processor performs the necessary computations (e.g. calculating remaining battery power) or processing routines (e.g. decoding) to read data that has been processed or data corresponding to the information that will be displayed from among the data stored in the memory device and transmits the data to the display unit. The display unit displays the received data as visual information. Here, the display unit may include a memory that stores the data received for displaying. The memory may be a frame memory. The frame memory, by which a data gradation signal compensation unit of the memory device stores and outputs gradation signals, may be built in within the data gradation signal compensation unit or may also be implemented as an external memory.

As such, because the conventional display unit requires a memory for temporarily storing data that will be displayed on the display unit, the cost becomes expensive, and the display screen (e.g. LCD) cannot be implemented in large sizes.

### SUMMARY

Thus, in order to solve the problems described above, the present invention provides a memory device having a data processing function, which is capable of independently performing commands received from the processor.

The invention also provides a memory device having a data processing function that separately performs processing for the data written in the memory device, to enhance the processing efficiency of the processor.

The invention also provides a memory device having a data processing function that improves the system processing efficiency and speed when outputting data written in the memory device through an external outputting device (e.g. video output unit and/or audio output unit).

The invention also provides a memory device having a data processing function, with which a display unit does not require a memory for temporarily storing the data to be displayed so that costs may be reduced and a large display screen may be implemented.

The invention also provides a memory device having a data processing function that includes a first processing unit, which performs a data processing command, and a second processing unit, which outputs written data through an external outputting device (e.g. a video output unit and/or audio output unit), whereby the efficiency of the system and the data processing speed can be improved.

Other problems the present invention solves will be apparent from the description of embodiments set forth below.

To achieve the foregoing objectives and resolve the problems of prior art, an aspect of the invention provides a memory device having a data processing function.

A memory device according to an embodiment of the invention may include: a process area, in which process command information may be written by a processor; a storage area, in which one or more data may be written; an output area, in which display data selected by the processor from among the data written in the storage area may be written; and a processing unit, which may perform one or more processes of copying data, computing data, and transmitting display data to an external outputting device, in correspondence to the process command information.

Here, the processing unit may include: a first command processing unit which may perform a corresponding process, if the process is copying data or computing the data; and a second command processing unit which may perform a corresponding process, if the process is transmitting display data to an external outputting device.

The process command information may also include command initiation information for initiating the corresponding process or command processing information for designating the type and content of the process.

If the process is copying data, the command processing information may include type information for designating the type of the process, address information of where source data is written in the storage area, and address information of where copied data of the source data is to be written.

If the process is computing data, the command processing information may include type information for designating the type of the process, a plurality of address information of where source data is written in the storage area, and address information of where data computed from the source data is to be written.

Also, if the process is transmitting display data to the external outputting device, the command processing information may include type information for designating the type of the process.

Here, the process area may include a mailbox control register, in which the command initiation information may be written, and a mailbox, in which the command processing information may be written.

The process area may further include a mail out box, in which may be written command completion information corresponding to the result of the first command processing unit performing the process.

Here, the mailbox control register may include a first mailbox control register, in which command initiation information for the first command processing unit may be written by the processor, and a second mailbox register, in which command initiation information for the second command processing unit may be written by the processor.

The processing unit may further include a command signal generating unit which may generate a command initiation signal and output the command initiation signal to the first command processing unit or the second command processing unit that will perform the process, when the command initiation information is written by the processor.

Also, the processing unit may further include: a first command signal generating unit, which may generate a command initiation signal corresponding to the command initiation information written by the processor and output the command initiation signal to the first command processing unit, if the process is copying data or computing the data; and a second command signal generating unit, which may generate a command initiation signal corresponding to the command initiation information written by the processor and output the command initiation signal to the second command processing unit, if the process is transmitting display data to an external outputting device.

In addition, the processing unit may output an interrupt signal to the processor when a process corresponding to the process command information is completed.

A memory device according to another embodiment of the invention may include: a process area, in which process command information may be written by a processor; a storage area, in which one or more data may be written; an output area, in which display data selected by the processor from among the data written in the storage area may be written; and a plurality of processing units, which may perform one or more processes of copying data, computing data, and transmitting display data to an external outputting device, in correspondence to the process command information.

Here, the plurality of processing units may include: a first processing unit, which may perform a corresponding process, if the process is copying data or computing the data; and a second processing unit, which may perform a corresponding process, if the process is transmitting display data to an external outputting device.

Here, the process command information may include command initiation information for initiating the corresponding process or command processing information for designating the type and content of the process.

In particular, if the process is copying data, the command processing information may include: type information for designating the type of the process, address information of where source data is written in the storage area, or address information of where copied data of the source data is to be written.

Also, if the process is computing data, the command processing information may include: type information for designating the type of the process, a plurality of address information of where source data is written in the storage area, or address information of where data computed from the source data is to be written.

If the process is transmitting display data to the external outputting device, the command processing information may include type information for designating the type of the process.

In addition, the process area may include a mailbox control register, in which the command initiation information may be written, and a mailbox, in which the command processing information may be written.

Also, the process area may further include a mail out box, in which may be written command completion information corresponding to the result of the first processing unit performing the process.

Here, the mailbox control register may include: a first mailbox control register, in which command initiation information for the first processing unit may be written by the processor, and a second mailbox register, in which command initiation information for the second processing unit may be written by the processor.

Also, the first process unit may further include a first command signal generating unit which may output a command initiation signal corresponding to the command initiation information written by the processor, if the process is copying data or computing the data.

The second process unit may further include a second command signal generating unit which may output a command initiation signal corresponding to the command initiation information written by the processor, if the process is transmitting display data to an external outputting device.

Furthermore, the first processing unit or the second processing unit may output an interrupt signal to the processor when a process corresponding to the process command information is completed.

A memory device shared by multiple processors, according to another embodiment of the invention, may include: a memory unit, in which certain data or process command information written by a processor may be written, and a plurality of processing units, which perform one or more processes of copying data, computing data, and transmitting display data to an external outputting device, in correspondence to the process command information, where the multiple processing units may be equipped separately in each of the processors.

Here, the multiple processing units may include a first processing unit which may perform a corresponding process, if the process is copying data or computing the data; and a second processing unit which may perform a corresponding process, if the process is transmitting display data to an external outputting device.

Also, the processing unit may include: a first command processing unit which may perform a corresponding process, if the process is copying data or computing the data; and a second command processing unit which may perform a corresponding process, if the process is transmitting display data to an external outputting device.

Also, there may be multiple memory units, with each memory unit allotted individually to each of the processors and equipped together with the processing unit as a pair.

Also, the memory unit may be composed of multiple partitioned areas in accordance with the number of processors coupled, where each partitioned area may be allotted individually to each of the processors and equipped together with the processing unit as a pair.

Here, the process command information may include command initiation information, for initiating the process, and command processing information, for designating the type and content of the process.

Here, the memory unit may include: a process area, in which the process command information may be written by the processor; a storage area, in which one or more data may be written; and an output area, in which display data selected by the processor coupled to the memory unit from among the data written in the storage area may be written.

The process area may include a mailbox control register, in which the command initiation information may be written, and a mailbox, in which the command processing information may be written.

The memory unit may further include a mail out box, in which may be written command completion information corresponding to the result of the processing unit performing the process.

In addition, the mailbox control register may include: a first mailbox control register, in which corresponding command initiation information may be written by the processor if the process is copying data or computing the data, and a second mailbox register, in which corresponding command initiation information may be written by the processor if the process is transmitting display data to an external outputting device.

The processing unit may further include a command signal generating unit which may determine whether or not the command initiation information is written and output a command initiation signal if the command initiation information is written.

Also, the processing unit may further include: a first command signal generating unit, which may generate a command initiation signal corresponding to the command initiation information written by the processor and output the command initiation signal to the first command processing unit, if the process is copying data or computing the data; and a second command signal generating unit, which may generate a command initiation signal corresponding to the command initiation information written by the processor and output the command initiation signal to the second command processing unit, if the process is transmitting display data to an external outputting device.

### BRIEF DESCRIPTION OF THE DRAWINGS

FIG. 1 is a block diagram showing the configuration of a memory device according to an embodiment of the invention.

FIG. 2 is a block diagram showing the configuration of a memory device and peripheral devices according to another embodiment of the invention.

FIG. 3 is a flow diagram showing command processing procedures according to an embodiment of the invention.

FIG. 4 is a flow diagram showing command processing procedures according to another embodiment of the invention.

FIG. 5 shows an example of the configuration of a copy command, which is one type of command processing information, according to an embodiment of the invention.

FIG. 6 shows an example of a dual-port memory device, in which the command processing relationships are shown for a plurality of processors, according to still another embodiment of the invention.

### DETAILED DESCRIPTION

The objectives, features, and advantages described above will become more readily appreciated from the following written description in relation to the appended drawings.

As the present invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the present invention.

While such terms as “first” and “second,” etc. may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any one item from among the plurality of related items disclosed.

When a component is mentioned to be “connected” to or “accessing” another component, this may mean that it is directly connected to or accessing the other component, but it is to be understood that another component may exist in-between. On the other hand, when a component is mentioned to be “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc. are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Embodiments of the present invention will be described below in detail with reference to the accompanying drawings, where those components are rendered the same reference numeral that are the same or are in correspondence, regardless of the figure number, and redundant explanations are omitted.

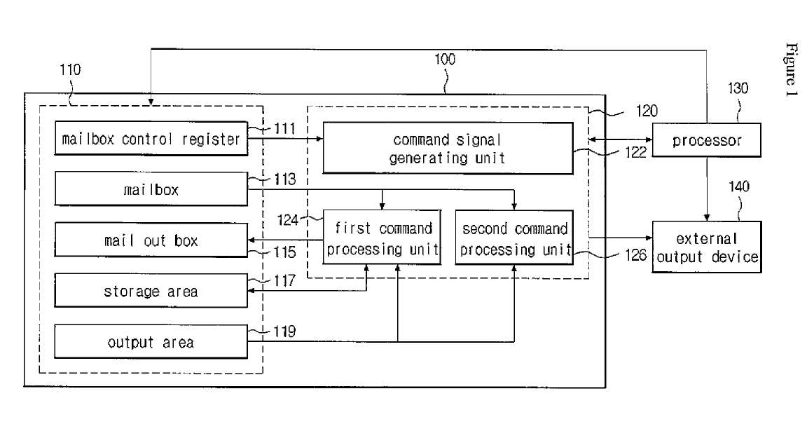

FIG. 1 is a block diagram showing the configuration of a memory device and peripheral devices according to an embodiment of the invention.

Referring to FIG. 1, a memory device 100 according to an embodiment of the invention includes a memory unit 110 and a processing unit 120.

The memory unit 110 can include a process area, a storage area 117, and an output area 119. The process area may further be divided into a mailbox control register 111, a mailbox 113, and a mail outbox 115.

The memory unit 110 may be any one of memory areas in a memory device, such as a DRAM or an SDRAM, which needs to be refreshed for data keeping.

In the memory area, those areas that will operate as the mailbox control register 111, mailbox 113, mail out box 115, storage area 117, and output area 119 can be designated beforehand or determined and allotted by a processor 130 during the booting of the processor 130.

The processor 130 may access the mailbox control register 111 to write command initiation information (for example, if the command initiation information is displayed as a value having a size of 1 bit, it may be ‘1’ or ‘0’). The mailbox control register 111 can be a certain storage space designated to have a size, for example, of several tens of bytes, and the processor 130 may read a value written in this area or write certain values.

To be more specific, the processing unit 120 may not perform any processing operation while ‘0’ is written (i.e. a value other than the command initiation information) in the mailbox control register 111, even when certain command processing information is written in the mailbox 113. Afterwards, if ‘1’ is written (i.e. the command initiation information) in the mailbox control register 111, a processing operation that corresponds with the command processing information written in the mailbox 113 can be performed (e.g. transmitting data written in the output area 119 to an external outputting device 140, copying data, or processing graphic data, etc.). Of course, the command initiation information may just as well be written as a value having a size of n bits (where n is a natural number), and it is apparent that various settings are possible regarding which wrote value or values are to be recognized as command initiation information.

Also, as the processing unit 120 can include multiple command processing units, the information written in the mailbox control register 111 can be further classified according to each command processing unit that will perform a command in correspondence with the command processing information. For example, if the command initiation information written in the command control register is displayed as a value having a size of 2 bits, no processing actions may be performed while ‘00’ is written in the mailbox register 120, even when certain command processing information is written in the mailbox 113, whereas if ‘11’ is written in the mailbox control register 111, the first command processing unit 124 can perform a processing operation (e.g. copying data, processing graphic data, etc.) corresponding to the command processing information written in the mailbox 113, and if ‘01’ or ‘10’ is written, the second command processing unit 126 can perform a process (e.g. transmitting data written in the output area 119 to an external outputting device 140, etc.) corresponding to the command processing information written in the mailbox 113.

The mailbox control register 111 is an area in which command initiation information may be written by the processor 130. The command initiation information is information for indicating the initiation of the command processing information written in the mailbox 113 by the processor 130. As described above, the command processing information of n bits (where n is a natural number) can be written in the mailbox control register 111.

Also, the mailbox control register 111 can be partitioned into multiple areas in accordance with the number of command processing units included in the processing unit 120. In this case, the command processing information of 1 bit may be written in each partitioned area. For example, the areas of the mailbox control register 111 can be configured to correspond to each of the first command processing unit 124 and the second command processing unit 126 included in the processing unit 120. Of course, there can be multiple mailbox control registers 111 (for example, a first mailbox control register and a second mailbox control register) in correspondence with the number of command processing units included.

The mailbox 113 is an area in which the command processing information (i.e. information representing the content of the command that is to be processed by the processing unit 120) is written by the processor 130.

The type of command processing information can be designated beforehand such that it can be recognized by the processing unit 120. As an example, the command processing information can be an output command, which may cause data written in the output area 119 to be transmitted to an external outputting device 140. In this case, one of the command processing units can process the output command. In another example, the command processing information can be an operational command, for computing the values written in certain addresses of the storage area 117 and writing the result in a new address, or a copy command, for taking data written in a first address and writing the data in a second address (e.g. a certain address in the storage area 117 or the output area 119). In this case, one of the command processing units can process the operational command. Other various types of command processing information are possible, as will readily be understood by the descriptions set forth below. The descriptions that follow will assume that processing according to an output command is performed by the second command processing unit 126 and processing according to other types of command is performed by the first command processing unit 124.

The mailbox 113 can be partitioned into multiple areas to be in agreement with the number of command processing units included in the processing unit 120. Of course, as in one embodiment of the present invention, the areas can be reserved for the mailbox 113 separately in correspondence with the first command processing unit 124 and second command processing unit 126 included in the processing unit 120 (for example, a first mailbox and a second mailbox).

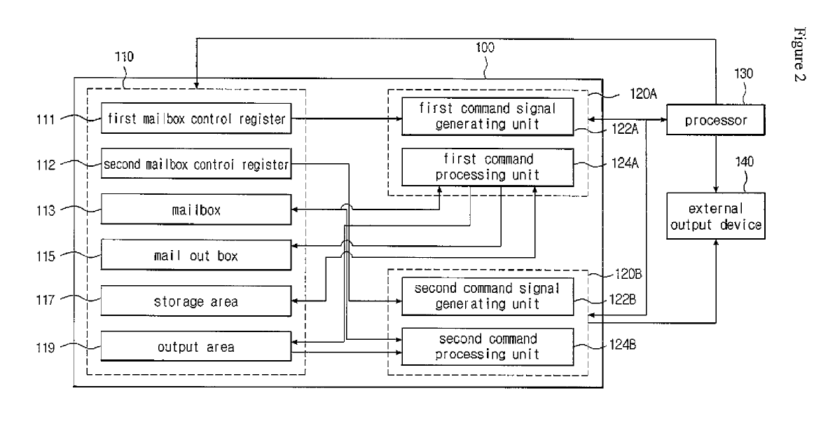

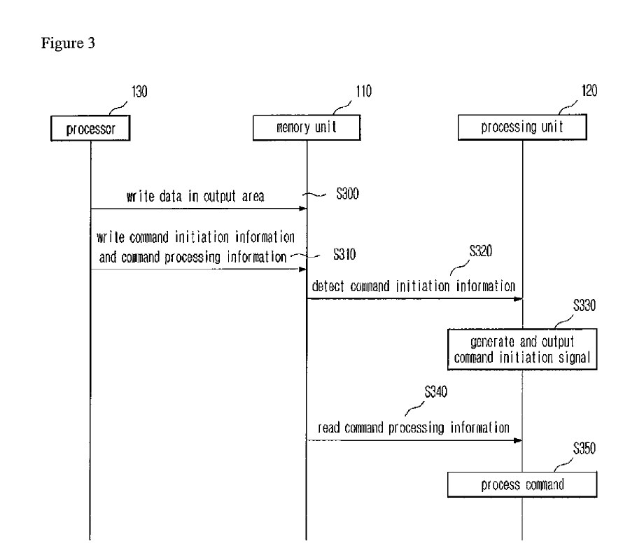

The mail out box 115 is an area in which command completion information, which is the resultant value of the processing performed by the first command processing unit 124 in correspondence to the command processing information, is written. Based on the type of the command processing information, the first command processing unit 124 can determine whether or not to write the command completion information in the mail out box 115. Each case will be described later in further detail with reference to FIGS. 2 and 3. For example, if the command processing information is an output command, to be performed by the second command processing unit 126, real-time outputting is sufficient, and thus it is possible to omit the writing of the command completion information. Also, if the command processing information is a copy command, to be performed by the first command processing unit 124, the address at which the processing results are to be written would be designated by the corresponding processor 130, whereby it is possible to omit the writing of the command completion information. As such, if the writing of the command completion information is unnecessary, designating and/or allotting the mail out box 115 may be unnecessary. However, in this specification, the descriptions will assume that a separate mail out box 115 is allotted such that the processor 130 can be provided with the processing results.

The storage area 117 is an area in which certain data is written. The processor 130 can process original data written in the storage area 117 and afterwards write the processed data again in the storage area 117, or can read data that is to be outputted through an external outputting device 140 from among the data written in the storage area 117 and write the data in the output area 117. Of course, the data written in the output area 119 can be outputted to the external outputting device 140, or the data processed by the processing unit 120 can be written in the storage area 117, in correspondence with the command processing information written in the processor 130. Also, the mailbox control register 111, mailbox 113, mail out box 115, and output area 119 described above can each be an area of the storage area 117 allotted for the respective designated purpose.

The output area 119 is an area in which data that will be transmitted to the external outputting device 140 by the second command processing unit 126 included in the processing unit 120 is written, when the command processing information is an output command. That is, the output area 119 can be used in the same or a similar manner as a memory equipped in a display unit according to prior art for temporarily storing data that will be displayed, whereby the external outputting device 140 according to an aspect of the present invention does not have to be equipped with such a memory. Of course, the area in which the second command processing unit 120 writes the data that will be transmitted to the external outputting device 140 can also be the storage area 117. In this case, the output command written from the processor into the mailbox 113 should contain the address number of the storage area 117 where the data to be transferred to the corresponding external outputting device 140 is written. Also, the data written in the output area 119 can be transmitted from the processor 130 and stored, or can be read by the processor 130 from the storage area 117 and written in the output area 119, or can also be data written in the output area 119 by the copy command or operational command, etc., of the processor 130. If the corresponding command is a copy command, the first command processing unit 124 can copy the data written in the first address to the output area 119. Also, if the corresponding command is an operational command for writing a computed value to the output area 119, the first command processing unit 124 can perform the command in correspondence with the command processing information and write the resultant data in the output area 119.

The processing unit 120 may include a command signal generating unit 122, a first command processing unit 124, and a second command processing unit 126. While FIG. 1 shows each of the command signal generating unit 122, first command processing unit 124, and second command processing unit 126 as an independent component for the convenience of explanation and understanding, if the function of the command signal generating unit 122, described below, is performed together by the first command processing unit 124 and/or second command processing unit 126, it is apparent that these can be integrated. It is also apparent that the processing unit 120 can be implemented as a software program (or a combination of software codes).

The command signal generating unit 122, when recognizing that command initiation information has been written in the mailbox control register 111, processes whether it is a command to be processed by the first command processing unit 124 or a command to be processed by the second command processing unit 126, and provides a command initiation signal for each case to the first command processing unit 124 or the second command processing unit 126. As described above, the mailbox control register 111 can have the command initiation information written in 2 bits or more to make it possible to determine which command processing unit the command initiation information is directed to, or can have multiple partitioned areas that correspond to the respective command processing units, or can be implemented as multiple mailbox control registers in correspondence with the respective command processing units. Likewise, the command signal generating unit 122 can also be implemented in a number corresponding to each of the command processing units (e.g. a first command signal generating unit and a second command signal generating unit). For example, assuming that the command initiation information has a 2 bit value, the command initiation information for initiating the command processing of the first command processing unit 124 can be configured as ‘11’, while the command initiation information for initiating the command processing of the second command processing can be configured as ‘01’ or ‘10’. The command signal generating unit 122 can detect whether or not command initiation information is written by continuously or periodically monitoring the mailbox control register 111.

A concise description of the processing actions of the command signal generating unit 122 is as follows. If, for example, ‘11’ (in case the first command processing unit 124 processes the command) is written as the command initiation information in the mailbox control register 112, the command signal generating unit 122 can generate and output a command initiation signal of a pre-designated form, using toggle signals and delay signals, which respectively allow each toggle signal to be outputted periodically (i.e. the toggle signals can be outputted in order at regular intervals). Of course, the command signal generating unit 122 can generate and output a command initiation signal also for the second command processing unit 126 (in which case the command initiation information can be ‘01’ or ‘10’) in the same manner.

When a command initiation signal is inputted from the command signal generating unit 122, the first command processing unit 124 reads the command processing information written in the mailbox 113 and performs a pre-designated processing action in correspondence with the command processing information (i.e. processes the corresponding command). In this case, the first command processing unit 124 can, according to the type of command processing information, write the resultant command completion information in the mail out box 115.

When a command initiation signal is inputted from the command signal generating unit 122, the first command processing unit 124 reads the command processing information written in the mailbox 113 and performs a pre-designated processing action in correspondence with the command processing information (i.e. processes the corresponding command). In this case, the first command processing unit 124 can, according to the type of command processing information, write the resultant command completion information in the mail out box 115 or write the command completion information in the storage area 117. Also, the command processing information that will be processed at the first command processing unit 124 can be for reading data written in a certain address of the storage area 117 and writing the data in another address (e.g. a copy command, etc.), computing (e.g. one or more of arithmetic computations, logarithmic, or exponential computations, etc.) read values and writing the result in another address (e.g. an operational command, etc.), etc. Furthermore, before the second command processing unit 126 processes the output command, the first command processing unit 124 can also read and process values written in a certain address of the storage area 117 to write the resultant value (e.g. data to be transmitted by the second command processing unit 126 to an external outputting device 140) in the output area 119 (or storage area 117).

On the other hand, when a command initiation signal is inputted from the command signal generating unit 122, the second command processing unit 126 can transfer the data that will be outputted to an external outputting device 140. Of course, the data to be outputted to the external outputting device 140 can be data written in the storage area 117 or data written in the output area 119.

When a command initiation signal is inputted from the command signal generating unit 122, the second command processing unit 126 reads the command processing information written in the mailbox 113 and performs a pre-designated processing operation in correspondence with the command processing information. In this case, the second command processing unit 126 can convert data written in the storage area 117 or the output area 119 into a format that can be outputted using the external outputting device 140 and transmit to the external outputting device 140 (e.g. an output command). Of course, in case the processor 130 is directly connected with the external outputting device 140 to perform a separate process (e.g. the processor processes graphic data and then outputs the data directly through the external outputting device), it is apparent that the processor 130 can control the external outputting device regardless of the memory device, and that the processing of data and the input/output relations of the data between the processor, the memory device, and the external outputting device can be set in various configurations.

If the command initiation information is written and the command processing information is an output command, the second command processing unit 126 transmits the data written in the output area 119 to the external outputting device 140 through a serial interface or a parallel interface. Here, it is apparent that the second command processing unit 120 can be configured to detect whether or not certain data is written in the output area 119, even when there is no command initiation information and/or command processing information written, and, if there is data written, output the data written at the corresponding point of time via the external outputting device 140. Also, the second command processing unit 126 can transmit data written not in the output area 119 but in the storage area 117 via the external outputting device 140. Of course, in this case, the address number within the storage area 117 where the transmitted data is written should be written in the command processing information, as already described above.

Also, the transmission size of the data transmitted by the second command processing unit 126 can be made the same as the sizes used for displaying data written in the memory of a conventional display unit. Here, the processor 130 can write certain data in the output area 119 and then write command initiation information in the mailbox control register 111 and write command processing information in the mailbox 113, or alternatively can write the command initiation information and command processing information and then write certain data in the output area 119. Also, after the command initiation information and command processing information are written, the second command processing unit 126 can continuously transmit the data written in the output area 119 or data renewed and written by the processor 130 to the external outputting device 140, until the command initiation information is deleted (or renewed to ‘0’).

However, the period for which the data written by the second command processing unit 126 in the output area 119 is transmitted to the external outputting device 140 should be incongruous with the point of time at which the processor 130 writes the data in the output area 119. This is because data consistency may be violated if multiple data-processing (e.g. read and/or write, etc.) components simultaneously access one storage area.

Thus, the time at which the second command processing unit 126 transmits the data written in the output area 119 to the external outputting device 140 can be designated to be the point of time at which an auto refresh is performed for the memory unit 110 or the storage area 117. This is because the auto refresh command would be inputted to the memory device 100 by the processor 130, the point of time at which the auto refresh is performed can be recognized by components of the memory device 100, and the processor 130 would not access the output area 119 for the corresponding length of time in order to process data.

Also, when the process action corresponding to the command processing information written by the processor 130 is completed, the processing unit 120 outputs an interrupt signal to the processor 130 to indicate that the performing of the command processing information is complete. Of course, if the command processing information is an output command, the second command processing unit 126 would output the data written in the output area 119 to the external outputting device 140 in pre-designated periods (e.g. the period for which an auto refresh is performed), whereby it may not be necessary to output an interrupt signal to the corresponding processor 130 for indicating that the performing of the command processing information is complete.

The processor 130 reads data that is to be displayed through the external outputting device 140 (e.g. basic information including one or more of current time, date, remaining battery power information, received signal strength information, etc., and/or processed multimedia information, etc., displayed through the display screen of a mobile communication terminal) from the storage area 117 and writes it in the output area 119. To this end, the processor can perform a computation necessary for the reading and writings of basic information (e.g. for calculating remaining battery power, etc.) or perform a processing procedure (e.g. decoding, etc.). Also, as described above, the processor can write the command processing information (the copy command, operational command, etc., as described above), which is to be processed by the first command processing unit 124 or second command processing unit 126 included in the processing unit, in the mailbox 113, and can write the command initiation information in the mailbox control register 111.

As described above, the command processing information written by the processor 130 can be to convert the data written in the output area 119 into a format that can be outputted through the external outputting device 140 and provide the data to the external outputting device 140 (e.g. an output command, etc.), read the data written in a certain address of the storage area 117 and write the data in another address (e.g. a copy command, etc.), or compute the read values (e.g. by one or more arithmetic computations) and write the result in another address (e.g. an operational command, etc.), etc.

Of course, in case the processor 130 is directly connected with the external outputting device 140 to perform a separate process (e.g. the processor processes graphic data and then outputs the data directly through the external outputting device), the processor 130 can control the external outputting device 140 regardless of the memory device 100. The processor 130 can also control the initiation/finish of an action of the external outputting device 140. It is apparent that the processing of data and the input/output relations of the data between the processor 130, memory device 100, and the external outputting device 140 can be set in various other configurations.

Also, the interrupt signal described above is a signal transferred by the processing unit 120 to the processor 130 to inform that the processing corresponding to the instructed command processing information is completed. The interrupt signal can be pre-designated to a form of signal transition (e.g. low to high, high to low) or edge signal (e.g. rising edge, falling edge, etc.), etc.

FIG. 2 is a block diagram showing the configuration of a memory device and peripheral devices according to another embodiment of the invention. As this embodiment of the invention in FIG. 2 is similar to the example in FIG. 1, the descriptions will not be presented again for the same components.

Referring to FIG. 2, a memory device 100 according to another embodiment of the invention includes a memory unit 110, a first processing unit 120A, and a second processing unit 120B.

The memory unit 110 can include a process area, storage area 117, and an output area 119. The process area can further be divided into a first mailbox control register 111, a second mailbox control register 112, a mailbox 113, and a mail out box 115.

The first mailbox control register 111 is an area in which, if the process command information is for copying data or computing the data, the processor 130 can write corresponding command initiation information. In this case, the command initiation information written in the first mailbox control register 111 is transferred to the first processing unit 120A.

Also, the second mailbox control register 112 is an area in which, if the process command information is for transmitting display data to an external outputting device 140, the processor 130 can write corresponding command initiation information. In this case, the command initiation information written in the second mailbox control register 112 is transferred to the second processing unit 120B.

The first processing unit 120A can include a first command signal generating unit 122A and a first command processing unit 124A. In this case, similar to the description regarding the processing unit 120 in FIG. 1, if the function of the first command signal generating unit 122A is performed together by the first command processing unit 124A, it is apparent that the two can be integrated.

The first command signal generating unit 122A, when recognizing that command initiation information has been written in the first mailbox control register 111, outputs a command initiation signal to the first command processing unit 124A. Here, the procedures for generating the command initiation signal will not be presented again, as it has been presented already with reference to FIG. 1.

When the command initiation signal is inputted from the first command signal generating unit 122A, the first command processing unit 124A reads the command processing information written in the mailbox 113 (in this case, a copy command, operational command, etc.) and performs a pre-designated processing operation in correspondence with the command processing information. Here, the command processing information which is to be processed by the first command processing unit can be for reading data written in a certain address of the storage area 117 and writing in another address (e.g. a copy command, etc.), or writing the read values in another address (e.g. an operational command, etc.), etc.

The second processing unit 120B can include a second command signal generating unit 122B and a second command processing unit 124B. In this case, similar to the description regarding the processing unit 120 in FIG. 1, if the function of the second command signal generating unit 122B is performed together by the second command processing unit 124B, it is apparent that the two can be integrated.

The second command signal generating unit 122B, when recognizing that command initiation information has been written in the second mailbox control register 112, outputs a command initiation signal to the first command processing unit 124A.

When the command initiation signal is inputted from the second command signal generating unit 122B, the second processing unit 120B reads the command processing information written in the mailbox 113 (in this case, an output command for outputting data to an outputting device, etc.) and performs a pre-designated process in correspondence with the command processing information. Here, the command processing information which is to be processed by the second command processing unit 124B can include information on the external outputting device.

Further descriptions on the remaining portions will not be presented, as they would be repeated from the example of the invention described for FIG. 1. Also, while the descriptions for FIG. 2 assume that one mailbox is implemented, it is apparent even without additional description that the mailbox 113 can be implemented in multiple numbers or partitioned into multiple areas to correspond with each of the command processing units.

FIG. 3 is a flow diagram showing command processing procedures according to an embodiment of the invention.

More specifically, FIG. 3 is a flow diagram showing command processing procedures, when the processor does not have to be provided again with the command completion information, which is the resultant value after the command processing information is processed in the processing unit 120. For example, this can be for a copy command processed in the first command processing unit 124 or an output command processed in the second command processing unit 126, and the descriptions below will assume the case of an output command processed in the second command processing unit 126. Also, these are procedures processed in the second command processing unit 126 equipped within the processing unit 120 according to the example of the invention described for FIG. 1.

Also, as described above, even if there is no command initiation information and/or no command processing information (i.e. an output command) written in particular, the second command processing unit 126 can determine whether or not certain data is written in the output area 119 at the point of time at which an auto refresh is performed, and if there is data written, can transmit the data to an external outputting device 140. However, the following descriptions will assume that the processing unit 120 transmits the data written in the output area 119 to the external outputting device 140, when the processor 130 has written command initiation information or command processing information.

In step S300, the processor 130 writes certain data in a pre-designated output area 119 such that the second command processing unit 126 outputs data to the external outputting device 140.

The data being written in the output area 119 can be received signal strength information with respect to a base station, icon information corresponding to the remaining battery power, etc., calculated by computational processing, or can be multimedia information processed by the processor 130. In the case that the data (e.g. video data) that will be outputted through the external outputting device 140 is greater than the size of the output area 119, the n-th data (where n is a natural number) written in the output area 119 can be transmitted by the second command processing unit 120 to the external outputting device 140, and then the processor 130 can subsequently write the (n+1)-th data in the output area 119. If the processing unit 120 transmits the data written in the output area 119 to the external outputting device 140 while an auto refresh is being performed, the processor 130 would write subsequent data in the output area 119 every time an auto refresh is completed, so that it is outputted through the external outputting device 140.

As described above, the processor 130 can write certain data in the output area 119 and then write the command initiation information and the command processing information, or alternatively can write the command initiation information and command processing information and then write certain data in the output area 119. For the latter case, the order of step S300 and step S310 would be changed.

Also, after the command initiation information or command processing information is written, the second command processing unit 126 can continuously transmit the data written in the output area 119 or data renewed and written by the processor 130 to the external outputting device 140, until the command initiation information is deleted (or renewed to ‘00’, etc.). To this end, a step of continuously or periodically writing in the output area 119 the data that will be outputted to the external outputting device 140 can be repeated at every point of time an auto refresh is completed after step S310. Also, step S350 can be repeated for transmitting the data written in the output area 119.

In step S310, the processor 130 writes command processing information, for processing by the second command processing unit 126, and command initiation information, for instructing the initiation of a command processing, in a pre-designated area of the memory unit 110. As described above, the areas in which the command processing information and the command initiation information are written can each be different. In this case, the processor 130 can complete the writing of the command initiation information and then write the command processing information, or can write the command processing information and then write the command initiation information.

When the second command processing unit 120 detects that command initiation information has been written in the memory unit 110 (step S320), the command signal generating unit 122 of the processing unit 120 generates a command initiation signal, for instructing the initiation of a process corresponding to the command processing information, and outputs the signal to the second command processing unit 126 (step S320). Whether there is command initiation information written or not can be detected by the command signal generating unit 122 or the second command processing unit 126, as described above, and in cases where the command signal generating unit 122 and the second command processing unit 126 are implemented in an integrated form, step S320 can be omitted.

The second command processing unit 126 reads the command processing information (e.g. output command) written in the memory unit 110 in step S340, and proceeds to step S350 to perform a corresponding processing action (i.e. transmit the data written in the output area 119 to the external outputting device 140 while an auto refresh action is being performed).

It is apparent that the sort of command and processing method of the command that the second command processing unit 126 will be made to perform from the command processing information can be designated beforehand, and that the second command processing unit 126 is implemented to be able to perform the corresponding operations. Therefore, it is apparent that the procedures performed by the second command processing unit 126 and the processing results will vary according to the read command processing information. For example, if the command processing information is an output command, the second command processing unit 126 would transmit the data written in the output area 119 to the external outputting device 140.

Although it is not described in excessive detail, according to one example of the invention, if the command processing information processed by the first command processing unit 124 is a copy command for copying the data written in a first address of the storage area 117 to a second address of the storage area 117, the first command processing unit 124 would read the data written in the first address and copy it to the second address.

While it is not shown in FIG. 3, the processing unit 120 (this can be the first command processing unit 124 or the second command processing unit 126) can output an interrupt signal, which is a signal that indicates that the processing related to the command processing information has been completed, to the processor 130 which wrote the command processing information. As described above, in the case of transmitting the data written in the output area 119 to the external outputting device 140, the settings can be such that normal processing is completed at the time of each auto refresh, and thus a separate interrupt signal may not have to be outputted.

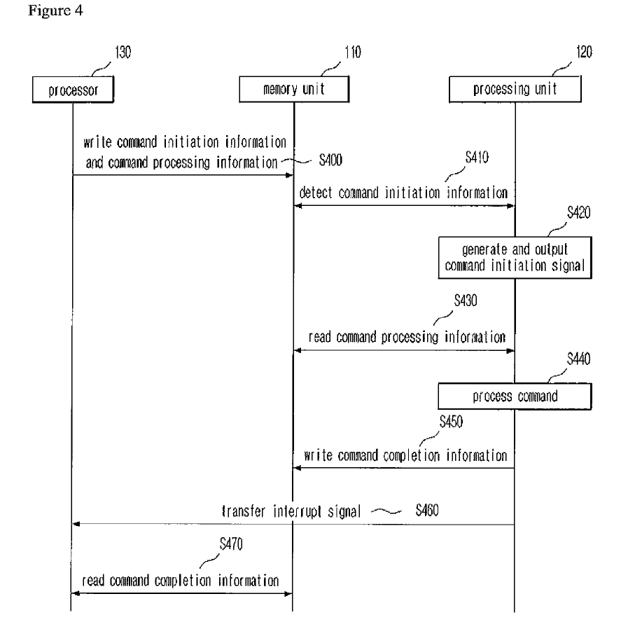

FIG. 4 is a flow diagram showing command processing procedures according to another embodiment of the invention.

More specifically, FIG. 4 is a flow diagram showing command processing procedures, when the processor 130 does not have to be provided again with the command completion information, which is the resultant value after the command processing information is processed in the first command processing unit 124. However, those descriptions that would be repeated from the descriptions for FIG. 3 will not be presented. Also, as with FIG. 3, the procedures are described in which a command is processed based on the example of the invention described for FIG. 1.

Also, since the order of step S300 can be changed/repeated or varied if the command processing information is an output command, FIG. 3 is shown with this step omitted. Steps S400 to S440 are the same as in the command processing method described with reference to FIG. 3, and thus will not be described in further detail.

In step S450, after processing the command according to the command processing information, the first command processing unit 124 writes command completion information, which is a value resulting from the command process corresponding to the command processing information, in a particular area of the memory unit 110. The command completion information can be allotted beforehand, or the area can be designated by the processor 130 and can, for example, be the mail out box 115. In this case, the command completion information needs to be returned from the processor 130. An example of the command processing information can be an operational command, for performing a computative process (e.g. creating a new resultant value using arithmetic computations) on information written in area C and information written in another area D of the storage area 117 within the memory unit 110 and writing in still another area E (e.g. a certain address in the storage area 117 or the mail out box 115). As described above, this can also be the storage area 117 or the output area 119, according to the content of the command processing information. The command completion information written in the output area 119 can be data that will be outputted by the second command processing unit 126 to the external outputting device, as described above. Of course, data stored in the storage area 117 can also be outputted by the second command processing unit.

In step S460, the processing unit 120 outputs an interrupt signal, which is a signal that indicates that the process related to the command processing information has been completed, to the processor 130 which wrote the command processing information.

In step S470, the processor 130 that has received the interrupt signal reads the command completion information from area E in which the command completion information is written. Of course, in some cases the processor 130 may not read the command completion information. For example, if a process corresponding to an incorrect operational command is performed by the processing unit 120, the processor 130 can delete, without reading, the command completion information where the command completion information is written. Also, if the command processing information is a copy command for copying data written in a first address of the storage area 117 to a second address of the storage area 117, the processing unit 120 would read the data written in the first address and copy the data to the second address.

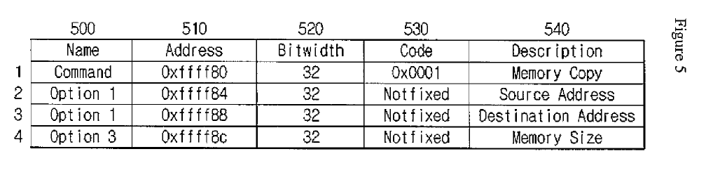

FIG. 5 shows an example of the configuration of a copy command, which is one type of command processing information according to an embodiment of the invention.

Referring to FIG. 5, the command processing information can include a first row which designates the type of the corresponding command, a second row which indicates the written address of the source data, a third row which indicates the destination address where the copied data is to be written, and a fourth row which indicates the size of the data to be written. However, it is apparent that the configuration of command processing information according to an aspect of the invention is not limited to the example of FIG. 5.

Describing in more detail the command processing information illustrated in FIG. 5, ‘0x0001’ (530-1, i.e. a copy command), which indicates the type of the corresponding command, is written in address ‘0xffff80’ (510-1) of the mailbox 113, while the address of where the source data is written within the storage area 117 (530-2) is written in address ‘0xffff84’ (510-2) of the mailbox 113. While the corresponding address (530-2) is listed as Notfixed in FIG. 5, it is apparent that an actual related address can be written in the corresponding field.

Similarly, the address where the copied data will be written (530-3) is written in address ‘0xffff88’ (510-3) of the mailbox 113, and the size of the data that will be copied (530-4) is written in address ‘0xffff8c’ (510-4) of the mailbox 113.

Of course, the configuration of the command processing information can vary according to the type of command.

For example, in the case of an output command, since the processing unit 120 would output the data written in the output area 119, just the command code (530-1) may be included, and if there are a multiple number of external outputting devices 140, information that specifies which of the external outputting devices 140 will be used for outputting can additionally be included.

Also, in the case of an operational command, the addresses of the source data which will be the object of computation can be included in multiple numbers, and the address where the computed result will be written can be included.

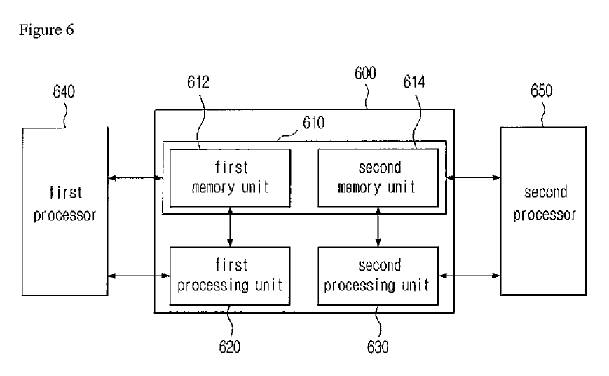

FIG. 6 shows an example of a dual-port memory device, in which the command processing relationships are shown for multiple processors according to still another embodiment of the invention.

It is apparent that the technical ideas of the invention can also be applied without limitation to a multi-port memory device having two or more ports. However, for the convenience of explanation and understanding, the description of the memory device 600 will assume the case of a dual-port memory device shared by two processors.

In the case of multiple processors 640, 650 sharing one memory device 600, the memory device 600 can be equipped with independent memory units 612, 614 and processing units 620, 630 that correspond respectively to each of the processors. That is, a first processor 640 would write the command processing information or command initiation information respectively in designated areas of a first memory unit 612, while a second processor 650 would write the command processing information or command initiation information in designated areas of a second memory unit 614.

The first processing unit 620 would perform a corresponding process using the command processing information written in the first memory unit 612 and then output an interrupt signal to the first processor 640, while the second processing unit 630 would perform a corresponding process using the command processing information written in the second memory unit 614 and then output an interrupt signal to the second processor 650. Of course, as described above, the outputting of an interrupt signal can be omitted, or can be applied in a different manner according to the type of command processing information.

Of course, the first processing unit 620 can be configured as the processing unit 120 described with reference to FIG. 1. Also, it is to be appreciated from the technical ideas of the present invention that the first processing unit 620 can be one of the multiple processing units 120A or 120B described with reference to FIG. 2 or can include multiple processing units 120A and 120B simultaneously. In other words, it is apparent that the first processing unit 620 can be configured to have any of a variety of forms.

Of course, it is apparent that the second processing unit 640 can also be configured in various forms, as with the first processing unit 620.

The configuration of the first memory unit and the second memory unit 612, 614 can be the same as or similar to the memory unit 110 described above with reference to FIG. 1. That is, if the storage area is logically allotted and set to allow access by each processor, the same configuration can be used as that of the memory unit 110 shown in FIG. 1. However, if the storage area is set to allow shared access, but the mailboxes 113, etc., are allotted independently, the configurations of the first and second memory units 612, 614 would be slightly different from that of the memory unit 110 in FIG. 1.

However, in the latter case, normal completion of a process may be impossible if the address where the resultant value of a processing instructed by each processor will be written is the same. To prevent this, the addresses where the processed results will be written can be set differently for each processor, or a step can be performed of checking the command processing information of each of the processing units 620, 630 (or processors).

Also, the memory device 600 can include output areas 119 corresponding to the number of external outputting devices 140 coupled. Thus, if one external outputting device 140 is coupled, one output area 119 would be sufficient.

However, as there may be cases in which multiple processors 640, 650 are to output certain data through the external outputting device 140 at the same time, the authority to decide which processor 640, 650 will write data in the output area 119 can be regulated by the processor having the authority control function, from among the multiple processors 640, 650. If one processor is a main processor, which controls the overall functions of a portable terminal, and another processor is an application processor, which performs supplementary functions (e.g. camera function, etc.) and which is controlled by the main processor, the authority can be controlled by the main processor.

Of course, there can be cases in which multiple processors 640, 650 write data simultaneously in one output area 119. For example, while performing a preview mode (i.e. a mode in a portable terminal having a camera function of displaying a real-time image corresponding to the object of photography through a display unit, performed before a capture mode of generating an encoded image), the main processor can write data in the output area 119 corresponding to basic information for displaying remaining battery power, etc., while the application processor can write real-time image data corresponding to the object of photography in the output area 119. In this case, the areas in the output area 119 in which the multiple processors may write data respectively can be designated beforehand or can flexibly be allotted by the main processor.

As set forth above, with an aspect the present invention, the memory device is able to independently perform commands received from the processor.

Also, an aspect of the present invention can enhance the processing efficiency of the processor that performs a process for the data written in the memory device.

Furthermore, an aspect of the present invention can improve system processing efficiency and speed when outputting data written in the memory device through an external outputting device (e.g. video output unit and/or audio output unit).

Also, with an aspect of the present invention, a display unit does not require a memory for temporarily storing the data to be displayed so that costs can be reduced, and a large display screen can be implemented.

In addition, an aspect of the present invention can include a first processing unit, which performs a data processing command, and a second processing unit, which outputs written data through an external outputting device (e.g. a video output unit and/or audio output unit), whereby the efficiency of the system and the data processing speed can be improved.

The drawings and detailed descriptions are for illustrative purposes only with regard to the present invention. They are used merely to explain the invention, and do not limit the invention as set forth in the claims. Therefore, those with ordinary skill in the art will understand that many variations and other embodiments may be made without departing from the scope of the invention. The true scope of protection for the invention will thus be defined only by the technical ideas of the invention as set forth in the appended claims.

What is claimed is:

1. A memory device comprising:
a process area in which process command information is written by a processor;
a storage area in which one or more data is written;
an output area in which display data selected by the processor from among the data written in the storage area is written; and
a processing unit configured to perform one or more processes of copying data, computing data, and transmitting display data to an external outputting device, in correspondence with the process command information.

2. The memory device of claim 1, wherein the processing unit comprises:
a first command processing unit configured to perform a corresponding process, if the process is copying data or computing the data; and
a second command processing unit configured to perform a corresponding process, if the process is transmitting display data to an external outputting device.

3. The memory device of claim 2, wherein the process command information comprises command initiation information for initiating the corresponding process or command processing information for designating the type and content of the process.

4. The memory device of claim 3, wherein, if the process is copying data, the command processing information comprises type information for designating the type of the process, address information of where source data is written in the storage area, and address information of where copied data of the source data is to be written.

5. The memory device of claim 3, wherein, if the process is computing data, the command processing information comprises type information for designating the type of the process, a plurality of address information of where source data is written in the storage area, and address information of where data computed from the source data is to be written.

6. The memory device of claim 3, wherein, if the process is transmitting display data to the external outputting device, the command processing information comprises type information for designating the type of the process.

7. The memory device of claim 3, wherein the process area comprises:
a mailbox control register in which the command initiation information is written; and
a mailbox in which the command processing information is written.

8. The memory device of claim 7, wherein the process area further comprises a mail out box in which command completion information is written, the command completion information corresponding to a result of performing the process by the first command processing unit.

9. The memory device of claim 7, wherein the mailbox control register comprises a first mailbox control register, in which command initiation information for the first command processing unit is written by the processor, and a second mailbox register, in which command initiation information for the second command processing unit is written by the processor.

10. The memory device of claim 2, wherein the processing unit further comprises a command signal generating unit configured to generate a command initiation signal and output the command initiation signal to the first command processing unit or the second command processing unit that is to perform the process, when the command initiation information is written by the processor.

11. The memory device of claim 7, wherein the processing unit further comprises:
a first command signal generating unit configured to generate a command initiation signal corresponding to the command initiation information written by the processor and output the command initiation signal to the first command processing unit, if the process is copying data or computing the data; and
a second command signal generating unit configured to generate a command initiation signal corresponding to the command initiation information written by the processor and output the command initiation signal to the second command processing unit, if the process is transmitting display data to an external outputting device.

12. The memory device of claim 1, wherein the processing unit outputs an interrupt signal to the processor when a process corresponding to the process command information is completed.

13. A memory device comprising:
a process area in which process command information is written by a processor;
a storage area in which one or more data is written;
an output area in which display data selected by the processor from among the data written in the storage area is written; and
a plurality of processing units configured to perform one or more processes of copying data, computing data, and transmitting display data to an external outputting device, in correspondence with the process command information.

14. The memory device of claim 13, wherein the plurality of processing units comprise:
a first processing unit configured to perform a corresponding process, if the process is copying data or computing the data; and
a second processing unit configured to perform a corresponding process, if the process is transmitting display data to an external outputting device.

15. The memory device of claim 14, wherein the process command information comprises command initiation information for initiating the corresponding process or command processing information for designating the type and content of the process.

16. The memory device of claim 15, wherein, if the process is copying data, the command processing information comprises type information for designating the type of the process, address information of where source data is written in the storage area, or address information of where copied data of the source data is to be written.

17. The memory device of claim 15, wherein, if the process is computing data, the command processing information comprises type information for designating the type of the process, a plurality of address information of where source data is written in the storage area, or address information of where data computed from the source data is to be written.

18. The memory device of claim 15, wherein, if the process is transmitting display data to the external outputting device, the command processing information comprises type information for designating the type of the process.

19. The memory device of claim 15, wherein the process area comprises:
a mailbox control register in which the command initiation information is written; and
a mailbox in which the command processing information is written.

20. The memory device of claim 19, wherein the process area further comprises a mail out box in which command completion information is written, the command completion information corresponding to a result of performing the process by the first processing unit.

21. The memory device of claim 19, wherein the mailbox control register comprises a first mailbox control register, in which command initiation information for the first processing unit is written by the processor, and a second mailbox register, in which command initiation information for the second processing unit is written by the processor.

22. The memory device of claim 19, wherein the first process unit further comprises a first command signal generating unit configured to output a command initiation signal corresponding to the command initiation information written by the processor, if the process is copying data or computing the data.

23. The memory device of claim 19, wherein the second process unit further comprises a second command signal generating unit configured to output a command initiation signal corresponding to the command initiation information written by the processor, if the process is transmitting display data to an external outputting device.

24. The memory device of claim 14, wherein the first processing unit or the second processing unit is configured to output an interrupt signal to the processor when a process corresponding to the process command information is completed.

25. A memory device shared by a plurality of processors, the memory device comprising:
a memory unit in which certain data or process command information written by a processor is written; and
a plurality of processing units configured to perform one or more processes of copying data, computing data, and transmitting display data to an external outputting device, in correspondence with the process command information, the plurality of processing units being equipped separately in each of the processors.

26. The memory device of claim 25, wherein the plurality of processing units comprise:
a first processing unit configured to perform a corresponding process, if the process is copying data or computing the data; and
a second processing unit configured to perform a corresponding process, if the process is transmitting display data to an external outputting device.

27. The memory device of claim 25, wherein the processing unit comprises:
a first command processing unit configured to perform a corresponding process, if the process is copying data or computing the data; and
a second command processing unit configured to perform a corresponding process, if the process is transmitting display data to an external outputting device.

28. The memory device of claim 25, having a plurality of memory units, wherein the memory unit is allotted individually to each of the processors and is equipped together with the processing unit as a pair.

29. The memory device of claim 25, wherein the memory unit is composed of a plurality of partitioned areas in accordance with the number of processors coupled, each partitioned area allotted individually to each of the processors and equipped together with the processing unit as a pair.

30. The memory device of claim 25, wherein the process command information comprises:
command initiation information for initiating the process; and
command processing information for designating the type and content of the process.

31. The memory device of claim 30, wherein the memory unit comprises:
a process area in which the process command information is written by the processor;
a storage area in which one or more data is written; and
an output area in which display data selected by the processor coupled to the memory unit from among the data written in the storage area is written.

32. The memory device of claim 31, wherein the process area comprises:
a mailbox control register in which the command initiation information is written; and
a mailbox in which the command processing information is written.

33. The memory device of claim 31, wherein the memory unit further comprises:
a mail out box in which command completion information is written, the command completion information corresponding to a result of performing the process by the processing unit.

34. The memory device of claim 32, wherein the mailbox control register comprises a first mailbox control register, in which corresponding command initiation information is written by the processor if the process is copying data or computing the data, and a second mailbox register, in which corresponding command initiation information is written by the processor if the process is transmitting display data to an external outputting device.

35. The memory device of claim 30, wherein the processing unit further comprises a command signal generating unit configured to determine whether or not the command initiation information is written and output a command initiation signal if the command initiation information is written.

36. The memory device of claim 30, wherein the processing unit further comprises:
a first command signal generating unit configured to generate a command initiation signal corresponding to the command initiation information written by the processor and output the command initiation signal to the first command processing unit, if the process is copying data or computing the data; and
a second command signal generating unit configured to generate a command initiation signal corresponding to the command initiation information written by the processor and output the command initiation signal to the second command processing unit, if the process is transmitting display data to an external outputting device.
